(19) United States
(12) Patent Application Publication
(10) Pub. No.: US 2007/0038647 A1
(43) Pub. Date: Feb. 15, 2007

(54) Management of media sources in memory constrained devices

(75) Inventors: Myron C. Thomas, Newcastle, WA (US); Darren R. Davis, Woodinville, WA (US); Gabriel S. DeBacker, Carnation, WA (US); Alec Barker, Woodinville, WA (US)

Correspondence Address: SENNIGER POWERS (MSFT), ONE METROPOLITAN SQUARE, 16TH FLOOR, ST. LOUIS, MO, 63102, US

(73) Assignee: Microsoft Corporation, Redmond, WA (US)

(21) Appl. No.: 11/197,068

(22) Filed: Aug. 4, 2005

(51) Int. Cl. G06F 7/00

(52) U.S. Cl. 707/100

(57) ABSTRACT

Managing media information on a computing device. The media information is stored in a plurality of media sources where at least one of the media sources is an external storage associated with the computing device and where at least one of the media sources is a local storage associated with the computing device. The computing device identifies one or more media objects stored in at least the local storage media source and the external storage media source. Metadata relating to the media information stored in the media sources is retrieved from the identified media objects and aggregated. A user interface is generated to display the aggregated metadata on the computing device.

### BACKGROUND

Digital portable media devices have expanded the reach of digital media content and provide the convenience of playback of digital media files. For example, portable media devices, such as MP3 players, cellular phones, smart phones, personal digital assistants (PDA), and the like, play digital audio and/or video files and display digital graphics or images. These portable media devices typically have a memory storage area to store the media files or media objects. In managing the stored media objects, the portable media devices customarily build a database structure, such as a media library, in the fixed or local memory storage area available on the device. This storage may be in a solid state or magnetic (fixed disk) format.

Currently, some portable media devices reserve an amount of memory storage area for the media library to organize the media objects, in addition to storing the media objects. For example, the portable media devices may store a set of tables or an index table listing the media objects by information such as content genre, content artist, content duration, content title, content collection (album), or the like relating to the media objects.

However, in existing portable media devices where the memory storage area has a limited capacity, reserving and maintaining the media library in the memory storage area hinders the amount of media objects that can be stored in the same memory storage area. Some portable media devices are configured to accept portable or removable memory sources, such as flash memory cards (e.g., Universal Serial Bus (USB) memory sticks, xD card), or the like, to store additional media objects. These portable media devices, however, fail to provide a full and rich media library management capability to manage media objects stored in one or more storage sources.

A simplistic approach to providing a richer media management experience involves trying to “pre-budget” an amount of space in the fixed or local memory storage on the device to hold information about the media objects available on each of the removable storage devices inserted in the device. Since removable storage continue to increase in storage limits, any attempt to “pre-budget” enough space on the memory storage area of the portable media device to store the maximum possible number of entries will result in placing a maximum size limit on the removable storage that can be used in the device. In addition, users typically want more space so this artificial limit may make the device unappealing to the users as the size of compatible removable storage grows larger than the maximum size the portable media device supports. With users having multiple cards or removable memory sources, a fixed amount of reserved memory or an expected limit of memory on the portable media device is impracticable to accommodate a large database in the portable media device.

### SUMMARY

Embodiments of the invention overcome the shortfalls of current systems by supporting storing a media library or media database content on removable read/write media instead of storing it on the local memory storage area of a portable media device. In particular, embodiments of the invention permit maintaining a database that includes information relating to the media objects in the most informative manner for the user. Embodiments of the invention enable portable media devices with a limited local storage to support removable flash storages for maintaining a media library that efficiently aggregates and manages media objects stored in the local storage, the removable storage sources, and/or other content repositories through some form of network connection. Embodiments of the invention also provide for intelligent background updating of the media database or media library to make sure that the portable media device stays in sync with the contents of the removable storage.

By finding, retrieving, and storing metadata of media objects stored in removable storage sources, alternative embodiments of the invention efficiently represent media objects to the user of the portable media device with a full and rich user experience with a complex view of a collection of available digital media objects. In addition, embodiments of the invention, in response to a query from a user, provide a query result identifying locations (either local or external) of media objects that are available to the user. In particular, embodiments of the invention represent the removable storage sources and remote media repositories to the host application of a portable media device.

Alternatively, the invention may comprise various other methods and apparatuses.

Other features will be in part apparent and in part pointed out hereinafter.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary embodiment of a system for managing media information on a computing device according to an embodiment of the invention.

FIGS. 2A-2E are exemplary diagrams illustrating management of media objects stored in removable storage sources according to an embodiment of the invention.

FIG. 3 is an exemplary flow chart illustrating operation of managing media information on a computing device according to an embodiment of the invention.

FIG. 4 is a block diagram illustrating an exemplary computer-readable medium on which the invention may be stored according to an embodiment of the invention.

FIG. 5 is a block diagram illustrating one example of a suitable computing system environment in which the invention may be implemented.

Corresponding reference characters indicate corresponding parts throughout the drawings.

### DETAILED DESCRIPTION

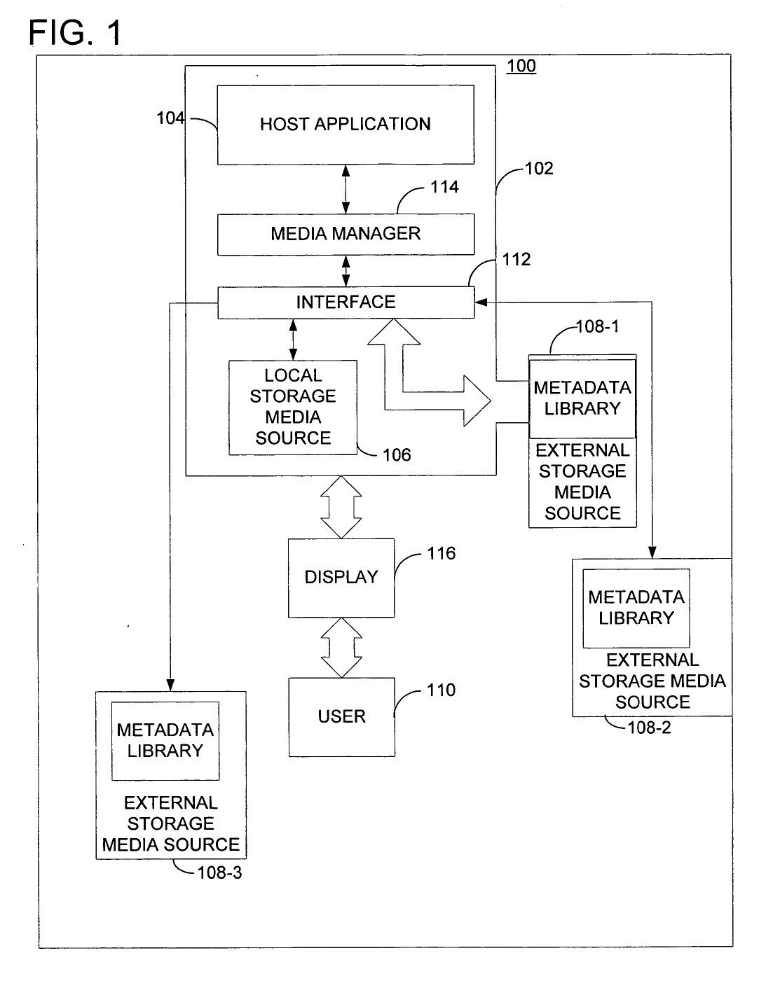

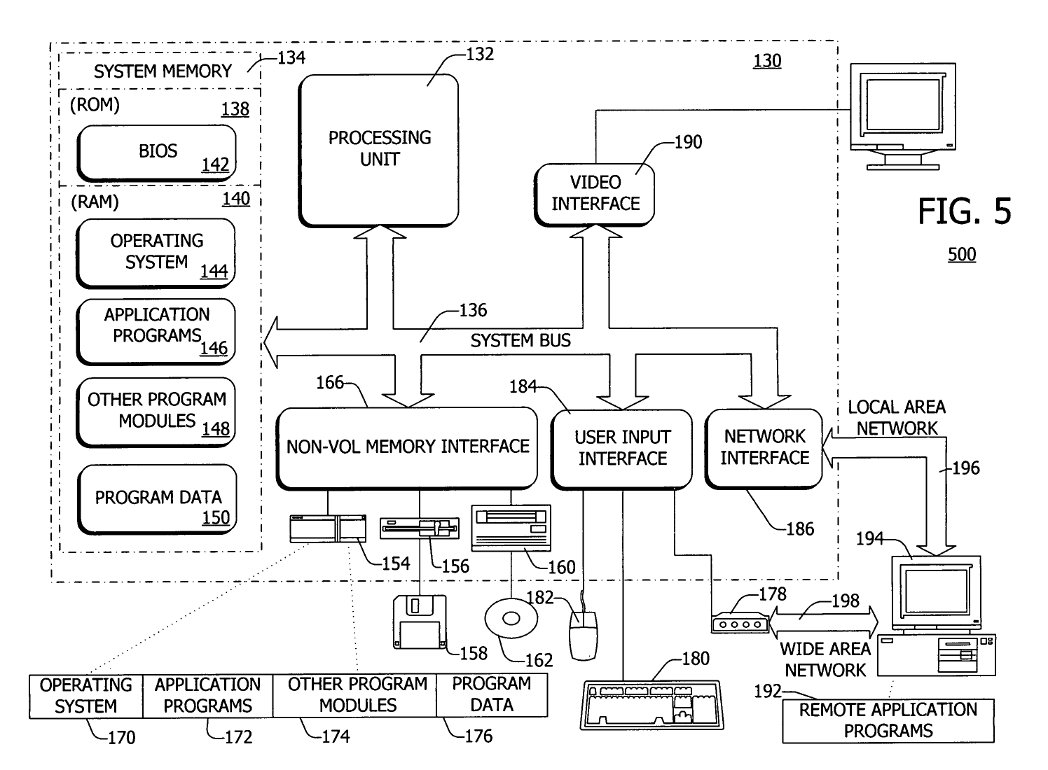

Referring first to FIG. 1, a block diagram illustrates an exemplary embodiment of a system 100 for managing media information on a computing device 102 according to an embodiment of the invention. For example, the computing device 102 includes a processor (not shown) configured for executing computer-executable instructions, routines, codes, or the like. In one embodiment, the processor (such as the processing unit 132 in FIG. 5) is included in the computing device 102 for executing applications, application programs, or software applications such as a host application 104. The computing device 102 may be a general purpose digital media player such as an MP3 player, a portable media player, a cellular phone, a PDA, a smartphone, or other digital media device that is capable of playback of digital media objects. In one embodiment, the digital media objects include music files in various file formats, picture files, or files including video recordings such as motion pictures or television programs. In particular, the host application 104 provides a number of operations, such as playback of the media objects, pause playing the media objects, fast-forward or rewind the playing of the media objects, or other operations that may be processed to playback media objects.

Still referring to FIG. 1, computing device 102 includes a plurality of media sources storing media objects. In one embodiment, computing device 102 includes a local storage media source 106 and one or more external storage media sources 108. For example, computing device 102 includes the local storage media source 106 for storing basic codes or data that are needed to be processed for operating computing device 102. Such basic codes or data include personalization settings, such as name of a user 110, an execution environment of computing device 102, such as date, time, or the like, or other initialization codes. The local storage media source 106 may also store media objects and information relating to a user preference of using computing device 102. In addition, each of the media objects includes media information such as title of the media object, artist of the media object, name of the album or series of the media object, duration of the media objects, type of the media object (e.g., sound recordings, motion pictures, video recordings, or the like), other similar data or information about the actual performance of the media objects, and other information.

Unlike existing portable media devices which purposefully reserve a portion of the local storage media source 106 to store media library or an organizational database to organize or manage media objects stored in the local storage media source 106, computing device 102 overcomes the shortcomings of known art by identifying the one or more external storage media sources 108 and by organizing one or more media library collections in each of the external storage media sources 108. As such, the need to reserve storage in local storage media source 106 is removed (thus expanding the usability of local storage media source 106), and embodiments of the invention efficiently manage media objects stored in external storage media sources 108.

Still referring to FIG. 1, computing device 102 includes an interface 112 for identifying one or more media objects stored in at least local storage media source 106 and external storage media sources 108. In one embodiment, the interface 112 establishes a data connection, either through a wired or wireless means, between computing device 102 and external storage media sources 108. For example, as shown in FIG. 1, external storage media source 108-1 may be a flash memory card, USB memory drive, or another removable storage device or memory-constrained device that may be inserted into or coupled with computing device 102 via interface 112. As another example, interface 112 may establish a wired or wireless connection between computing device 102 and external storage media source 108-2, which may be a hard drive or a memory area of another computing device, such as a computer 130 in FIG. 5. In yet another example, interface 112 may establish a wired or wireless connection between computing device 102 and external storage media source 108-3, which may be a storage or a memory area having media objects available in a network, such as an intranet, an internet, or the like. The computing device 102 also includes a display 116 for displaying a user interface generated for displaying the aggregated metadata on computing device 102.

In an alternative embodiment, a set of basic primitives is defined for external storage media sources 108 and are operational across the sources represented to enable host application 104 to gain easy access to the different metadata stored in external storage media sources 108 via interface 112.

In one embodiment, playback of digital media objects involves reproducing both the content of the media objects as well as the media information associated with the content of the media objects. While host application 104 is configured to playback the content of the media objects, computing device 102 includes a media manager 114 for managing the media information by retrieving metadata associated with the content of the media objects or with the media objects. In one embodiment, media manager 114 is capable of managing media objects in various media formats in each of the different media sources, such as local, external, removable, or remote. In an alternative embodiment, media manager 114 notifies host application 104 or user 110 of changes of media objects in local storage media source 106 or external storage media sources 108.

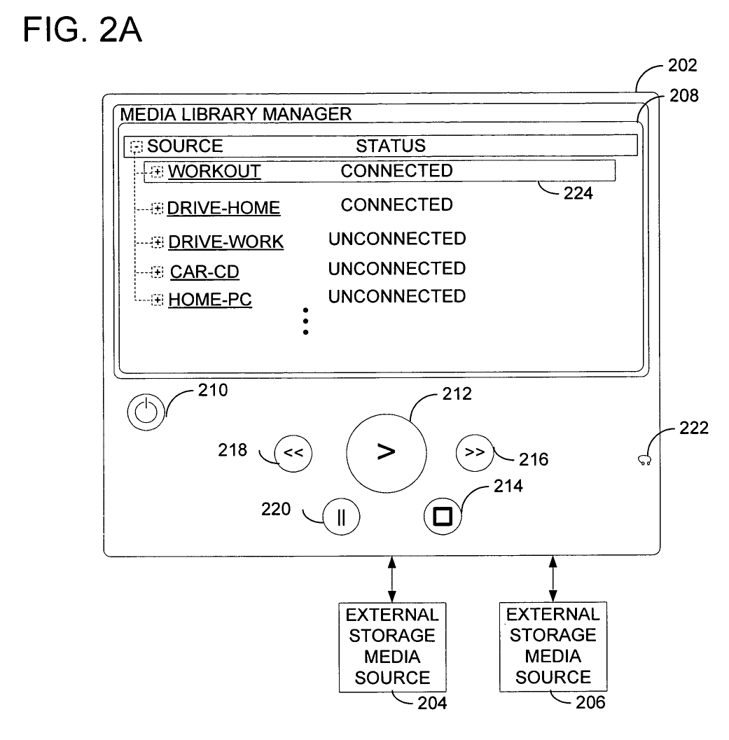

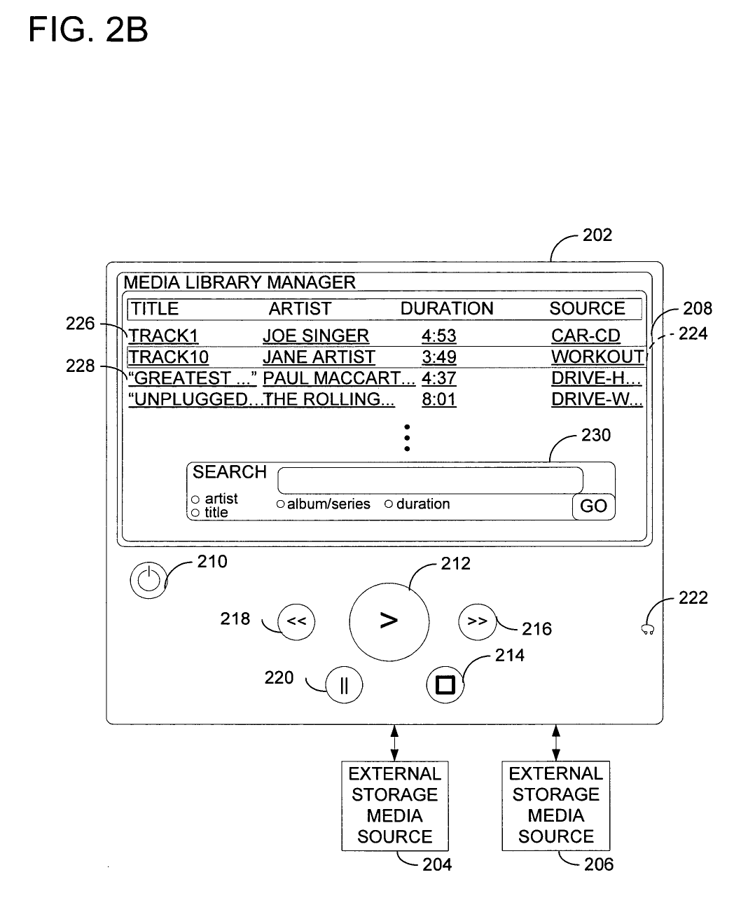

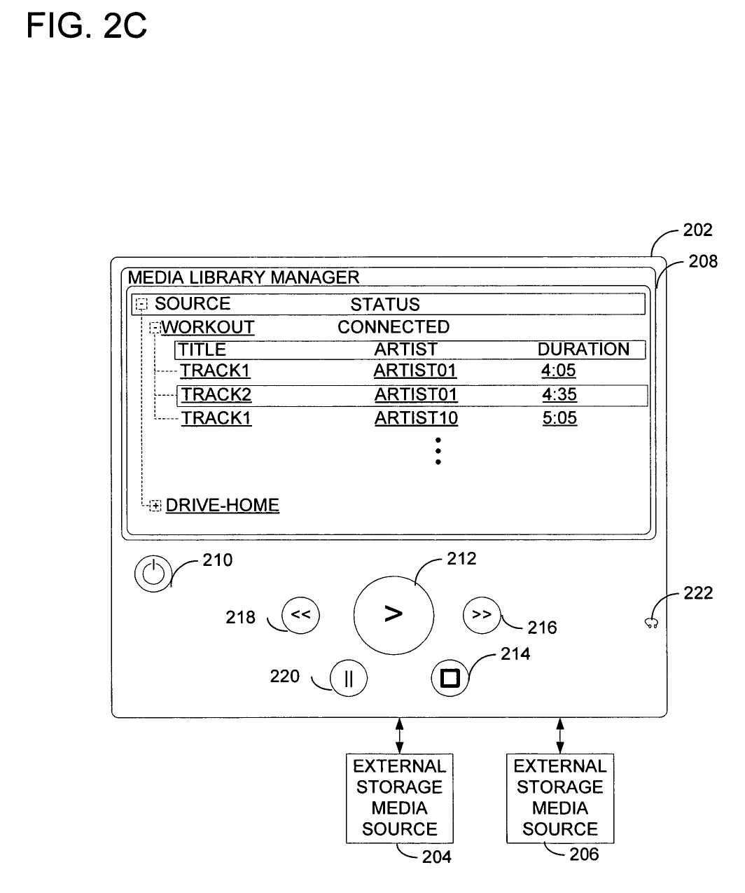

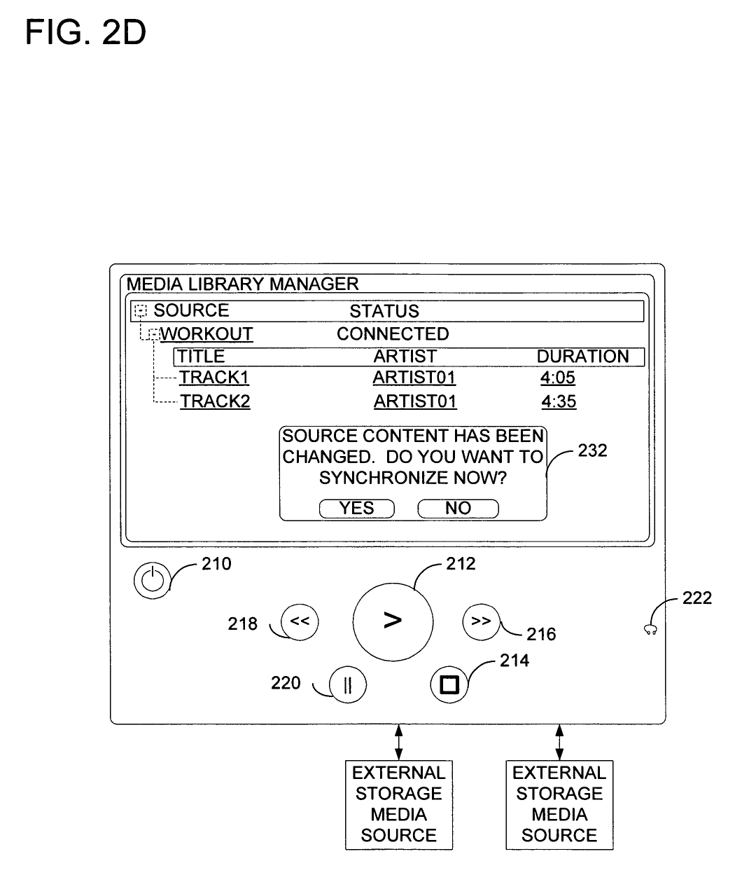

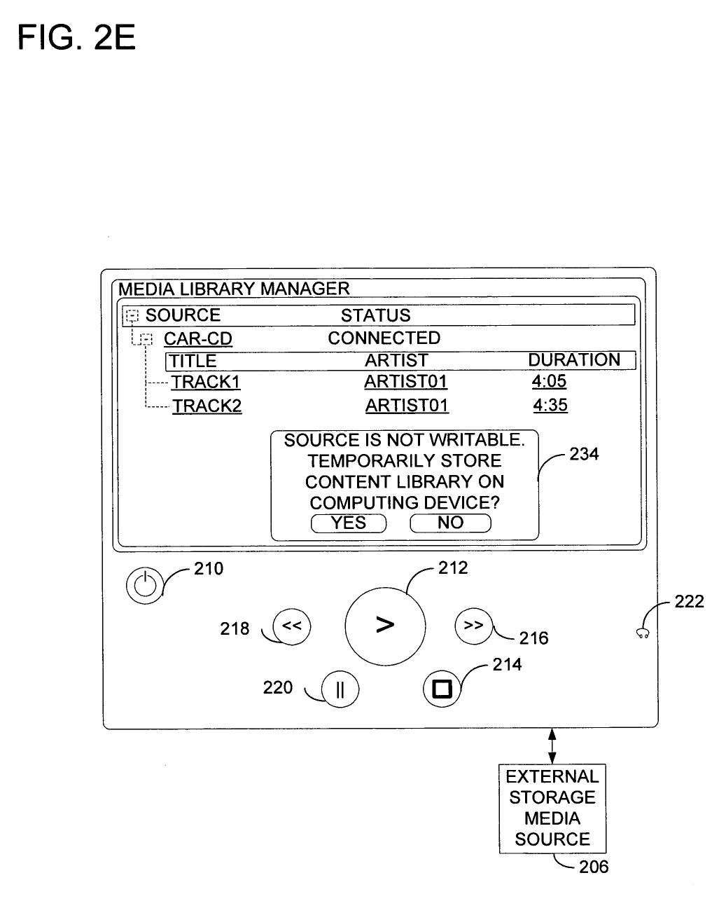

FIGS. 2A-2E illustrate management of media objects stored in external storage media sources according to an embodiment of the invention. A computing device 202 includes media manager 114 for managing media objects stored in external storage media sources 204 and 206 connected via interface 112. As illustrated in FIG. 2A, computing device 202 provides a display 208 and a set of operational controls, such as a power switch 210, a play button 212, a stop button 214, a fast forward button 216, a rewind button 218, and a pause button 220. The computing device 202 may also provide an audio output plug 222 for headphones. In one embodiment, the computing device 202 may also provide an output to non-wired peripherals, such as Bluetooth headphones, or the like. After interface 112 establishes a data connection between computing device 102 and external storage media sources 204 and 206, media manager 114 recognizes or becomes aware of each of the media sources. In an alternative embodiment, media manager 114 may include a set of routines or codes to recognize external storage media sources 204 and 206. In yet another embodiment, media manager 114 may provide a configurable component to dynamically determine a set of routines or code through a component registry, XML file, or other technology to recognize external storage media sources 204 and 206. In an embodiment, media manager 114 includes a media source enumerator component to notify media manager 114 when new sources become available or existing sources become unavailable (i.e., when they are removed).

Still referring to FIG. 2A, once media manager 114 recognizes or identifies the media sources (e.g., external storage media sources 204 and 206), media manager 114 initially retrieves the name of the media sources and notifies host application 104 that a new source is available. In particular, media manager 114 identifies one or more media objects stored in the media sources before retrieving metadata from the identified media objects, where the metadata is related to media information stored in the media sources. In an alternative embodiment, host application 104 may elect to present the retrieved metadata to user 10 with some form of notification or simply wait until the user goes to investigate which sources are available. As illustrated in FIG. 2A, display 208 of computing device 202 displays a list of media sources available to the user 10. For example, display 208 shows a number of media sources, such as “WORKOUT”, “DRIVE-HOME”, “DRIVE-WORK”, “CAR-CD”, and “HOME-PC”. In addition, display 208 illustrates a status of connection between computing device 202 and external storage media sources, such as “CONNECTED” or “UNCONNECTED”.

In one embodiment, media manager 114 may retrieve metadata relating to media information stored in media sources by performing a bind operation between host application 114 of computing device 202 and a media source. For example, the bind operation involves initializing a temporary memory structure with some amount of data from the information stored in the media source. This information may be stored on the media source, such as a simple delimited text file, an XML file, or a binary format specific to a particular database implementation, or some other proprietary binary data storage mechanism. In another embodiment, the information used to initialize the temporary in memory structure may require a conversion of the bind operation or bind requests into a more formal network standard which transfers the requests remotely to another computing device located somewhere on a intranet, internet, or other network. Next, the bind operation is completed when the initialized structure provides a binding between the media library manager and the media metadata available on the media source. Following the bind operation the media source typically enters a servicing mode or a stand-by mode. In an alternative embodiment, media manager 114 may perform a bind operation on a media source that also supports some form of indexing or fast retrieval structure or implementation.

For example, after retrieving metadata from media sources, media manager 114 is in a standby mode or a pure management mode where media manager 114 is to notify host application 104 of changes of media objects on the media sources. In an alternative embodiment, media manager 114 may enter an aggregation mode by aggregating the retrieved metadata to enable host application 104 to present a single result set containing aggregated results across all available media sources rather than a result set representing media information from a single media source, such as shown in FIG. 2B. In addition, user 110 may also select one of the identified media sources. For example, user 110 may use fast-forward button 216 or rewind button 218 to move up and down a highlighted box 224 on display 208. In the illustrated example, user 110 selects the external storage media source “WORKOUT”, which may be a removable flash card that has established a wired connection with computing device 202 via interface 112.

Referring now to FIG. 2B, an exemplary display configuration for displaying media information based on retrieved metadata from media sources, such as external storage media sources 204 and 206. For example, as illustrated, a retrieved metadata 226 shows a media object named “TRACK 1” with an artist named “Joe Singer” and with a duration of “4:53” is retrieved from the media source “CAR-CD”. Another retrieved metadata 228 indicates a media object named “TRACK 10” with an artist named “Paul MacCart . . . ” and with a duration of “4:37” is retrieved from the media source “DRIVE-H . . . ”. Also illustrated (shown by the highlight box 224) is a retrieved metadata, selected by user 110, indicating a media object named “TRACK 10” with an artist named “Jane Artist” and with a duration of “3:49” from a media source “WORKOUT”. By presenting retrieved metadata as illustrated, embodiments of the invention advantageously provide a rich aggregated user experience to user 110 with a complete and full view of media objects stored in media sources, both local and external, such that user 110 may easily navigate and locate media objects. In addition, such user experience overcomes shortcomings of prior systems or designs by accommodating a plurality of external storage media sources and building an efficient and compact metadata library in each of the plurality of external storage media sources.

In another embodiment, regardless of the mode (e.g., pure management mode or aggregation mode) that media manager 114 operates, media manager 114 defines a secondary set of application programming interfaces (APIs) enabling consistent access (e.g., query) to the metadata available in the media sources, either local or remote. In an alternative embodiment, computing device 202 receives a query from a user for querying the metadata and provides a result in response to the received query from the user. As illustrated, a search box 230 is provided to user 110 for searching media objects managed by media manager 114. In another embodiment, the query language used to communicate between computing device 202 and the plurality of media sources may be as complex as a fully functional query language similar to Structured Query Language( SQL) or as simple as a way to request different pre-defined results based on a couple of variables. In another embodiment, a simple query language may be defined to identify a media source having media information and to establish a set of property restrictions as Boolean expressions. By providing this rich and full user experience, user 110 may efficiently operate computing device 202 to manage and organize media objects stored in the plurality of media sources.

In an alternative embodiment, a query API may be defined to be broadly used across different media sources. For example, the semantics for accessing a local database stored in a local storage media source having metadata information may be quite different from those necessary for requesting information from an external storage media source. By focusing the API on the minimal set of functionality needed to efficiently represent media information, alternative embodiments of the invention build a platform that can scale across a wide range of metadata sources. As such, the minimal set of functionality of the API may be implemented in each media source, either local or external, to map the media sources to whatever semantics that are appropriate for the particular data source. As such, user 110 may use computing device 202 to conveniently retrieve and query media information stored in the media sources.

FIG. 2C illustrates another display format of retrieved metadata according to an embodiment of the invention. In particular, media manager 114 displays aggregated metadata according to the media sources. For example, the illustrated example shows that the media objects of a media source “WORKOUT” are displayed. In one embodiment, the displayed metadata may be ordered by different fields, such as by artist, title, duration, etc. In another embodiment, the displayed metadata may be ordered by a frequency of a usage preference of user 110. In an alternative embodiment, media manager 114 resolves duplication of media objects when aggregating the retrieved metadata as a function of the usage preference. For example, suppose there are two sources, such as “WORKOUT” and “CAR-CD” that include an identical media object such as TRACK1 by ARTIST01. The media manager 114 may determine that “WORKOUT” is a preferred media source because user 110 uses the “WORKOUT” media source more often than the “CAR-CD” media source. As such, “TRACK1” by “ARTIST01” of the “WORKOUT” media source may be displayed first.

In one embodiment where there is only one media source, either local or external, storing media objects, media manager 114 may organize the displayed metadata as an ordered list, un-ordered list, or other format that may be defined by the media source.

In an alternative embodiment, media manager 114 may cause the consistency of one or more media sources to be validated in an effort to detect changes to contents in the one or more media sources. For example, as discussed above in the standby or pure management mode, FIG. 2D illustrates a synchronization notification dialog box 232 notifying user 110 whether to synchronize the aggregated metadata displayed on computing device 202 to reflect the changes in the media source. In this operation, the contents of one or more of the media sources may be read by the media manager 114, and the metadata extracted may be used to update the information available from the media source. In another embodiment, the media manager 114 may case a media source to enter a data validation mode in which the media manager 114 performs a heuristic scan of the media source looking for changes to the contents by referring to information such as creation or modification date for a particular media object. In yet another embodiment, the media source may be presented with a transaction log or other organizational structure that lists the changes made to the media represented by this media source. The media source may then parse the transaction log or change list and perform the necessary updates to the metadata information stored on the removable device for the media that has changed. In an alternative embodiment, media manager 114 may issue a command via the media source to a remote media storage source to request that the remote source validate the consistency of the metadata against the available media.

In yet another embodiment, media manager 114 may also notify user 110 when one or more external storage media sources is not writable. For example, FIG. 2E illustrates a dialog box 234 to notify user 10 that the media source is not a writable/re-writable storage media source. The user 110 is next asked to permit temporarily storing content library on computing device 202. In another embodiment, a read-only implementation of the invention may be created to handle support query and other functionality of the read-only media source (e.g., a non-rewritable CD-ROM) without requesting permission from the user. For example, if the user attempts to modify the contents of the metadata on the read-only media source or device, the user is informed that this is not possible and is prevented from making the changes. In this embodiment, the media source is responsible for examining the contents of the removable read-only memory and building up the necessary metadata based on parsing the contents of the media. In another embodiment, the media source may take advantage of a remote metadata repository (e.g., remote network storage media source) capable of reporting metadata based on serial number or some other identifying piece of information that can be extracted from the read-only storage media.

In a further alternative embodiment, when the media library or the organized media structure on one of the external storage media sources 108 exceeds or is close to the storage capacity of the external storage media source, the alternative embodiment of the invention dynamically enables the user 110 to browse through all available storage media sources to find the media object in each of the storage media sources before referencing the media object in the media library on the storage media source.

In yet a further embodiment, media manager 114 may dynamically adjust speed of retrieving or aggregating metadata from one or more external media sources. In this particular embodiment, during retrieval of metadata, media manager 114 returns some basic information about a specific set of results without actually returning the full result set. For example, if user 110 is connected to a network based external storage media source over a relatively slow connection (e.g., dial-up), media manager 114 may optimize the network traffic to provide the best possible user experience. In another example, for a large set of retrievable metadata, media manager 114 may initially return information about the number and type of items available, and only return the name or other details of the media objects upon demand from user 110, such as when user 110 presses the play button.

Other display configurations or formats, apart from those illustrated in FIGS. 2A-2E, may be implemented without departing from the scope of the invention. In addition, other media information fields, such as artist, album/series, and/or title, may be organized appropriately without departing from the scope of the invention.

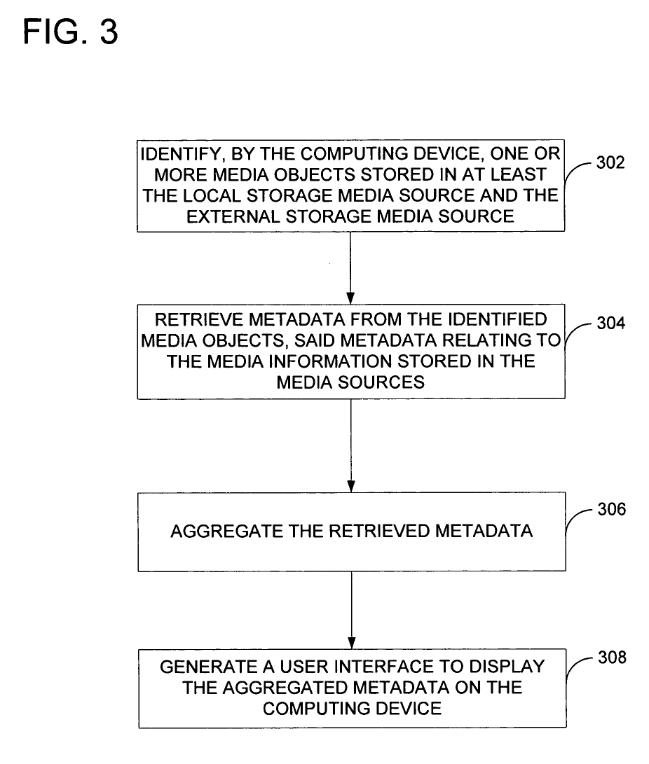

FIG. 3 is a flow chart illustrating exemplary operations for managing media information on a computing device according to an embodiment of the invention. At 302, the computing device identifies one or more media objects stored in at least the local storage media source (e.g., local storage media source 106) and the external storage media source (e.g., external storage media sources 108). Metadata is retrieved from the identified media objects at 304. The metadata relates to the media information stored in the media sources. At 306, the retrieved metadata is aggregated. For example, media manager 114 aggregates the retrieved metadata in the aggregate mode. At 308, aspects of the invention generate a user interface to display the aggregated metadata on the computing device, such as those illustrated from FIGS. 2A-2E.

It is to be understood that while embodiments of invention retrieve metadata relating to media information stored in the media sources, other similar type of data may also be retrieved to be retrieved and aggregated by media manager 114 without departing from the scope of the invention.

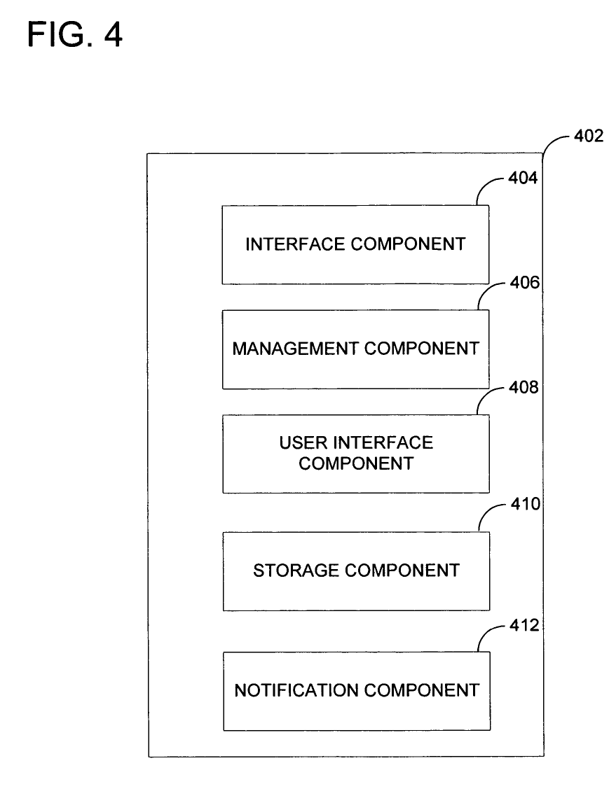

FIG. 4 is a block diagram illustrating an exemplary computer-readable medium 402 on which the invention may be stored according to an embodiment of the invention. The computer-readable medium includes an interface component 404 for identifying one or more media objects stored in the plurality of media sources. The plurality of media sources stores media information and at least one of the media sources comprises an external storage associated with the computing device and at least one of the media sources comprises a local storage associated with the computing device. The computer-readable medium 402 also includes a management component 406 for retrieving metadata from the identified media objects. The metadata relates to the media information stored in the media sources. The management component 406 also aggregates the retrieved metadata. The computer-readable medium 402 further includes a user interface component 408 for displaying the aggregated metadata to a user. In an alternative embodiment, computer-readable medium 402 includes a storage component 410 for storing the retrieved metadata as a library collection on the one of the plurality of corresponding external storage media sources. In yet another alternative embodiment, computer-readable medium 402 includes a notification component 412 for notifying the user when the media objects are available from the plurality of media sources after the interface component 404 establishes the connection with the computing device.

FIG. 5 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 5 illustrates operating system 144, application programs 146, other program modules 148, and program data 150.

The computer 130 may also include other removable/non-removable, volatile/nonvolatile computer storage media. For example, FIG. 5 illustrates a hard disk drive 154 that reads from or writes to non-removable, nonvolatile magnetic media. FIG. 5 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 5, provide storage of computer readable instructions, data structures, program modules and other data for the computer 130. In FIG. 5, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 5 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 5 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions such as those illustrated in FIG. 3 to manage media information on a computing device. The media information is stored in a plurality of media sources where at least one of the media sources comprises an external storage associated with the computing device and where at least one of the media sources comprises a local storage associated with the computing device. The computing device identifies one or more media objects stored in at least the local storage media source and the external storage media source. Metadata relating to the media information stored in the media sources is retrieved from the identified media objects and aggregated. A user interface is generated to display the aggregated metadata on the computing device.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above system and method without departing from the scope of the invention, it is intended that all matter contained in the above description and shown in the accompanying drawings shall be interpreted as illustrative and not in a limiting sense.

What is claimed is:

1. A computerized method of managing media information on a computing device, said media information being stored in a plurality of media sources, at least one of said media sources comprising an external storage associated with the computing device and at least one of said media sources comprising a local storage associated with the computing device, said computerized method comprising:
identifying, by the computing device, one or more media objects stored in at least the local storage media source and the external storage media source;
retrieving metadata from the identified media objects, said metadata relating to the media information stored in the media sources;
aggregating the retrieved metadata; and
generating a user interface to display the aggregated metadata on the computing device.

2. The computerized method of claim 1, wherein the computing device comprises a memory-constrained device.

3. The computerized method of claim 1, further comprising establishing a data connection between the computing device and the external storage media source associated therewith.

4. The computerized method of claim 1, further comprising receiving a query from a user for querying the metadata and wherein generating the user interface comprises providing a result set to the user in response to the received query.

5. The computerized method of claim 1, further comprising validating consistency of the aggregated metadata when the external storage media source reestablishes a data connection between the computing device and the external storage media source.

6. The computerized method of claim 1, further comprising notifying the user when the media objects are available from the plurality of media sources.

7. The computerized method of claim 1, further comprising storing the retrieved metadata as a library collection on the one of the plurality of corresponding external storage media sources for display in the user interface on the computing device.

8. The computerized method of claim 1, wherein one or more computer-readable media have computer-executable instructions for performing the computerized method recited in claim 1.

9. A system of managing media information on a computing device, said system comprising:
a plurality of media sources storing media information, at least one of said media sources comprising an external storage associated with the computing device and at least one of said media sources comprising a local storage associated with the computing device;
an interface for identifying, by the computing device, one or more media objects stored in at least the local storage media source and the external storage media source;
a media manager for retrieving metadata from the identified media objects, said metadata relating to the media information stored in the media sources, said media manager being configured to aggregate the retrieved metadata; and
a display on the computing device for displaying the aggregated metadata to a user.

10. The system of claim 9, wherein the computing device comprises a memory-constrained device.

11. The system of claim 9, wherein the interface includes a data connection established between the computing device and the external storage media source associated therewith.

12. The system of claim 11, wherein the media manager is configured to notify the user when the media objects are available from the plurality of media sources after the interface establishes the connection with the computing device.

13. The system of claim 9, further comprising a user interface on the computing device for receiving a query from the user to query the metadata and wherein the media manager provides a result set to the user in response to the received query.

14. The system of claim 9, wherein the media manager is configured to validate consistency of the aggregated metadata when the external storage media source reestablishes a data connection between the computing device and the external storage media source.

15. One or more computer-readable media having computer-executable instructions for managing media information stored in a plurality of media sources, said computer-executable instructions comprising:
an interface component for identifying one or more media objects stored in the plurality of media sources, said plurality of media sources storing media information, said at least one of said media sources comprising an external storage associated with the computing device and at least one of said media sources comprising a local storage associated with the computing device;
a management component for retrieving metadata from the identified media objects and aggregating the retrieved metadata, said retrieved metadata relating to the media information stored in the media sources; and
a user interface component for displaying the aggregated metadata to a user.

16. The computer-readable media of claim 15, further comprising a storage component for storing the retrieved metadata as a library collection on the one of the plurality of corresponding external storage media sources.

17. The computer-readable media of claim 15, wherein the storage component stores one or more usage preferences of the computing device and wherein the management component resolves duplication of media objects when aggregating the metadata by determining a preferred media source containing the duplicated media objects as a function of the usage preferences of the computing device.

18. The computer-readable media of claim 15, wherein the interface component establishes a data connection between the computing device and the one of the plurality of media sources associated therewith and wherein the user interface component, in response to a request from the user, retrieves the media objects from the plurality media sources having an established connection between the plurality of media sources and the computing device.

19. The computer-readable media of claim 18, further comprising a notification component for notifying the user when the media objects are available from the plurality of media sources after the interface component establishes the connection with the computing device.

20. The computer-readable media of claim 15, wherein the management component further validates consistency of the aggregated metadata when the external storage media source reestablishes a data connection between the computing device and the external storage media source.
